(19) United States
(12) Patent Application Publication
(10) Pub. No.: US 2022/0198837 A1
(43) Pub. Date: Jun. 23, 2022

(54) VISIT RECORD PROVIDING SYSTEM

(71) Applicant: TOYOTA JIDOSHA KABUSHIKI KAISHA, Toyota-shi (JP)

(72) Inventors: Katsuhisa Yoshikawa, Miyoshi-shi (JP); Shigeru Inamori, Nagoya-shi (JP); Mitsuyoshi Ohno, Miyoshi-shi (JP); Kosuke Sakakibara, Toyota-shi (JP); Nao Yamamoto, Chiyoda-ku (JP); Shinpei Yasukawa, Chiyoda-ku (JP); Katsuhito Yamauchi, Seto-shi (JP); Hiroaki Namba, Toyota-shi (JP); Tatsuya Ono, Yokohama-shi (JP)

(21) Appl. No.: 17/551,632

(22) Filed: Dec. 15, 2021

(30) Foreign Application Priority Data
Dec. 17, 2020 (JP) 2020-208927

(51) Int. Cl. G07C 1/02; G06T 7/20; G06V 40/16

(52) U.S. Cl. CPC G07C 1/02; G06V 40/174; G06V 40/172; G06T 7/20

(57) ABSTRACT

A path acquiring unit that tracks a visitor of an amusement facility, and acquires a movement path of the visitor, and a print creating unit that creates a visit record by combining the movement path acquired by the path acquiring unit with a picture acquired at a prescribed place on the acquired movement path are included, and the visit record created by the print creating unit is provided to the visitor.

### CROSS REFERENCE TO RELATED APPLICATION

This application claims priority to Japanese Patent Application No. 2020-208927 filed on Dec. 17, 2020, which is incorporated herein by reference in its entirety including the specification, claims, drawings, and abstract.

### TECHNICAL FIELD

The disclosure relates to a visit record providing system that provides a visit record to a visitor of an amusement facility in commemoration of visit.

### BACKGROUND

In various kinds of facilities, various services for visitors are present, and provision of pictures of the visitors in the facility is widely conducted. For example, pictures taken by a photographer of the facility are presented to a visitor, and the visitor can obtain a picture of a visit record by selecting the picture that they desire.

JP 2009-278534 A indicates that when a visitor to a facility desires, the visitor as an object is automatically photographed, and a photographed image is provided to the visitor. In other words, by comparing feature information on a face portion extracted from a photographed image photographed by a camera in the facility with feature information extracted from a photographed image of a visitor who is leaving the facility, a photographed image of the visitor in the facility is identified, and the identified image is printed out and provided to the visitor. Moreover, JP 2009-278534 A also indicates that a visitor is caused to wear a wrist band capable of transmitting an ID, and an image of the visitor identified by a signal from the wrist band is taken and provided to the visitor.

Here, according to the related art, a visitor can acquire a photographed image of the visitor, which is a precious visit record, photographed at the facility without the photograph being taken by the visitor themselves or people they are with. However, the image acquired at a specified place provides only a fragmentary visit record. There is room for improvement in terms of recording a better memory.

### SUMMARY

One aspect of the disclosure is a visit record providing system that provides a visit record to a visitor of an amusement facility in commemoration of a visit, the visit record providing system including a processor configured to: acquire movement path information for the visitor of the amusement facility; acquire a picture of the visitor taken at a prescribed place on the movement path; and create the visit record by combining the acquired movement path with the picture, in which the visit record created by the processor is provided to the visitor.

The picture can include a picture acquired by a camera installed in advance in the amusement facility or a camera installed in a movable body that moves in the amusement facility.

The picture can be a picture acquired by identifying the visitor through face authentication.

A plurality of pictures for the identified visitor can be acquired, a level of excitement of the visitor can be detected, and the picture in which the detected level of excitement is high can be selected.

The processor can acquire information related to the place where the picture is acquired, and add the acquired information to the visit record.

A printer is included as a device in the amusement facility, and in a case where the visit record is output from the printer, the visit record can be printed out by adding a specific image stored in advance.

The picture is provided with a map of the facility and the movement path, so that a visit record that commemorates the visit constitutes a better memory.

### BRIEF DESCRIPTION OF DRAWINGS

Embodiments of the present disclosure will be described based on the following figures, wherein:

FIG. 1 is a schematic diagram illustrating an overall configuration of a visit record providing system;

FIG. 2 is a block diagram illustrating a schematic configuration of a management system 100;

FIG. 3 is a block diagram illustrating a configuration example of a facility camera 24; and

FIG. 4 is a diagram schematically illustrating one example of printed matter (a print) of a visit record.

### DESCRIPTION OF EMBODIMENTS

Hereinafter, an embodiment according to the disclosure will be described based on the drawings. Note that the disclosure is not limited to the embodiment descried herein.

Overall Configuration

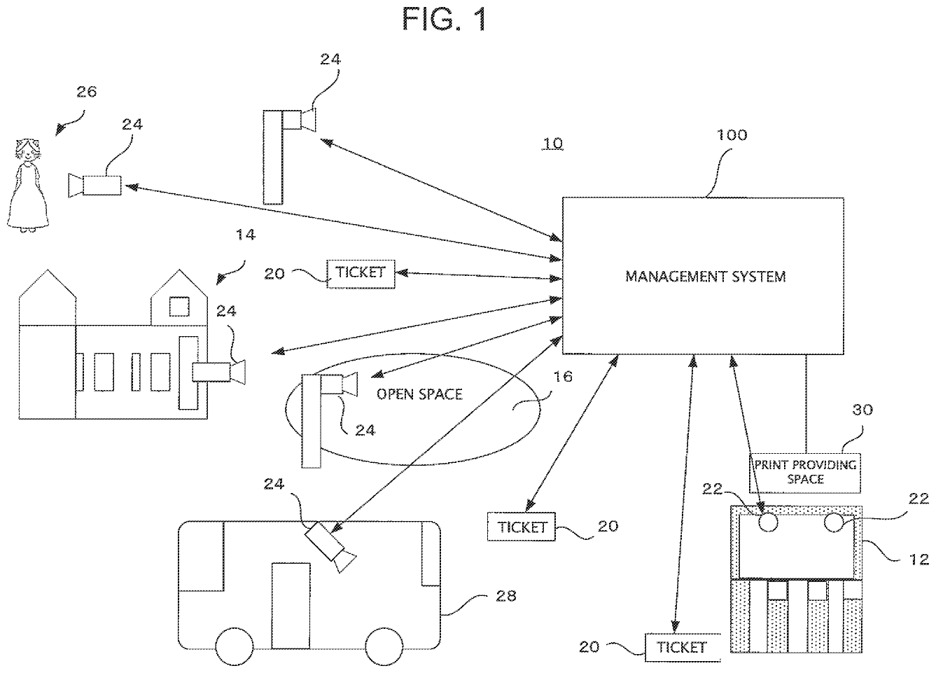

FIG. 1 is a schematic diagram illustrating an overall configuration of a visit record providing system. An amusement facility 10 is, for example, a pay facility and includes a gate 12, and entrance and exit of visitors are limited to the gate 12. Note that the amusement facility 10 is divided into areas of a plurality of tastes, and the visitors enter and exit through a separate gate 12 for each area in some cases.

A plurality of attractions 14 are present in the facility, and the visitors can enjoy the plurality of attractions 14. Moreover, an open space 16 and the like are also provided, and an outdoor attraction such as a parade may be held herein.

A ticket 20 is necessary for a visitor to pass through the gate (entrance gate) 12 and enter the facility, and an electronic ticket like a mobile terminal, a smartphone, and the like can be used as the ticket 20. Note that a paper ticket on which a bar code or the like is printed may be used. Further, in the present embodiment, entrance cameras 22 are provided in the gate 12 or at adjacent positions, and a facial image of a visitor is stored in association with the ticket 20 using the entrance camera 22. In other words, the gate 12 and the entrance cameras 22 are connected to a management system 100, and the management system 100 stores therein ticket information from the gate 12 in association with a facial image from the entrance camera 22. In a case where the ticket 20 that is an electronic ticket or a smartphone is available, the management system 100 also stores therein user information on the visitor, such as a name and a nickname, in association with the facial image.

Moreover, the GPS or the like can be mounted on the ticket 20, and position information on the ticket 20 may be provided to the management system 100 all the time. Therefore, the management system 100 can grasp a position of the visitor all the time, and can perform processing such as facial recognition by identifying a visitor who is highly probably present in the image, when processing images from a facility cameras 24.

A large number of facility cameras 24 are provided inside and outside the attractions 14 in the amusement facility, sides of a passage, and the like, and take images of the visitors all the time. The facility cameras 24 are also connected to the management system 100, and the management system 100 performs image processing on an image that is sent from each facility camera 24, and also performs facial recognition by comparing the processed image with the facial image of the user stored as user information. The image of the user identified by the facial recognition is stored in association with the identified visitor.

Note that for the identified visitor, a photo opportunity is recognized from facial expressions and the like, and the facility camera 24 may be controlled to acquire a still image with high resolution in this case. AI or the like subjected to prescribed learning may be used to determine the photo opportunity. Moreover, the facility cameras 24 may be provided in a photograph spot 26 where a picture is taken together with a stuffed toy of a character related to the amusement facility, and in a facility bus 28 that is a movable body in the facility.

Further, a print providing space 30 including a printer that is a printing unit for printed matter is provided near the gate 12, and a visit record is printed out here and is provided to the visitor.

Management System

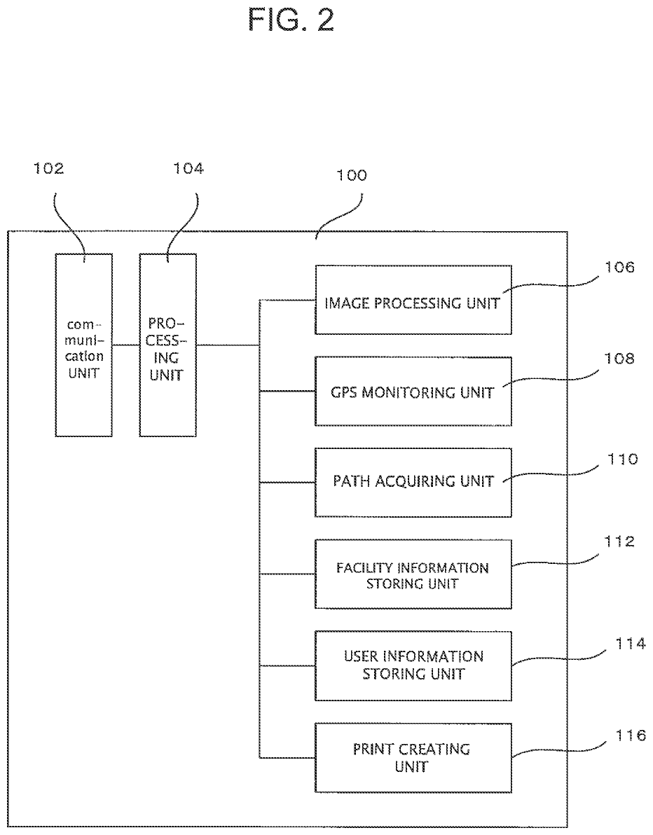

The management system 100 is provided in the amusement facility, is a computer that performs various kinds of data processing and controls various kinds of devices such as the facility cameras 24, and includes a processor for performing necessary processing. FIG. 2 is a block diagram illustrating a schematic configuration of the management system 100.

A communication unit 102 communicates with the entrance cameras 22, the ticket 20, the facility cameras 24, a device (for example, a printer), and the like in the print providing space 30. The communication may use radio communication, wired communication, and communication via a communication channel such as the Internet, alone or in combination. A processing unit 104 is connected to the communication unit 102. The processing unit 104 performs various kinds of data processing necessary in the management system 100. An image processing unit 106, a GPS monitoring unit 108, a path acquiring unit 110, a facility information storing unit 112, a user information storing unit 114, a print creating unit 116, and the like are connected to the processing unit 104.

The image processing unit 106 performs facial recognition from images that are sent from the entrance camera 22 and the facility camera 24, and recognizes visitors individually. Note that in addition to the facial recognition, visitors may be recognized from a combination of information on clothes, their figure, and the like.

The GPS monitoring unit 108 acquires information from a GPS transmitter of the ticket 20, and grasps a position of a visitor who carries the ticket 20.

The path acquiring unit 110, that is a path acquiring unit, grasps a position of a visitor all the time on the basis of information from the GPS monitoring unit 108, and detects a movement path of the visitor from a history thereof. Moreover, in a case where position information on a visitor is not acquired from the ticket 20, the path acquiring unit 110 recognizes a position of the visitor from a relation between the visitor recognized by the image processing unit 106 and a camera by which the image has been acquired, and tracks the visitor. Further, the path acquiring unit 110 detects a movement path of the visitor from the acquired position history. Note that in a case where the visitor gets on the facility bus 28 and moves, the path acquiring unit 110 may receive provision of a position of the facility bus 28, and grasp a movement path. Note that the GPS is mentioned merely as one example of a position detection system, but the position detection system is not limited thereto, and another position detection system may be used.

The facility information storing unit 112 stores therein various kinds of information on the amusement facility, and stores therein pictures inside and outside of the attraction 14 and various kinds of information related to the attraction 14, a function, position information, and the like of the equipment in the facility.

The user information storing unit 114 stores therein information on visitors, and stores therein various kinds of information on the visitors. When a visitor is a person who has been registered in advance as a user, the user information storing unit 114 stores therein a user ID, a registered name, an age, an address, a nickname, a contact address, and the like. Moreover, the user information storing unit 114 stores therein a facial recognition result from the image acquired by the entrance camera 22, an image of a visitor acquired by the facility camera 24, the movement path of the visitor acquired by the path acquiring unit 110, and the like, in association with the visitor (user ID).

The print creating unit 116 that functions as a record configuring unit creates a visit record to be printed out in the print providing space 30, and supplies the data to the printer in the print providing space 30, thereby controlling printing of the visit record. Note that the print creating unit 116 may successively create a visit record to be printed on the basis of successive incoming information.

Note that before print data is actually printed out, the print data may be shown to and checked by the visitor, and may be then printed out, or the visitor may select print data among a plurality of print candidates.

In addition, data may be provided to a user who wants that data, or the data may be stored for a certain period and may be accessible by the user ID. Moreover, in a case where a visitor has printed print data in the print providing space 30 before the visitor exits, such a bonus may be offered that a specific image stored in advance, such as images of a character and an attraction in the amusement facility (for example, premium image), is incorporated into the picture, or can be superimposed as a background image.

Facility Camera

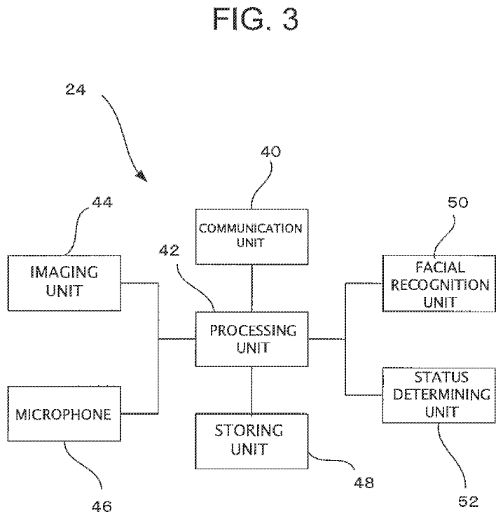

FIG. 3 is a block diagram illustrating a configuration example of the facility camera 24. The facility camera 24 may supply an acquired image to the management system 100 without any change, or may uniquely have a function such as facial recognition. The facility camera 24, which independently has the functions such as facial recognition, can reduce the communication data amount, or shorten the reaction time.

A communication unit 40 communicates with the management system 100. A processing unit 42, which is connected to the communication unit 40, performs various kinds of data processing. An imaging unit 44, a microphone 46, a storing unit 48, a facial recognition unit 50, and a status determining unit 52 are connected to the processing unit 42. The imaging unit 44 is a device that acquires a moving image and a still image using a C-MOS element and the like, and outputs an image signal. The microphone 46 acquires sound, and outputs a sound signal. The storing unit 48 stores therein an image and the like acquired by the entrance camera 22 and to be sent from the management system 100, and stores therein the image signal and the sound signal respectively acquired by the imaging unit 44 and the microphone 46.

The facial recognition unit 50 performs facial recognition on the image acquired by the imaging unit 44, and identifies a visitor on the basis of the image of the visitor stored in the storing unit 48. The facial recognition may be performed directly from a moving image, or may be performed using a still image cut out from the moving image. As mentioned above, in a case where the facial recognition unit 50 has received information indicating that an identified visitor is highly probably included in the image from the management system 100, the facial recognition unit 50 may identify the visitor with priority. Moreover, the facial recognition unit 50 may receive information on a movement path of a visitor from the management system 100, and limit a target for the facial recognition. Further, in a case where the facial recognition unit 50 has recognized an identified visitor, the facial recognition unit 50 supplies the information to the management system 100.

The status determining unit 52 determines a status of a visitor who is a photographed subject from the image acquired by the imaging unit 44 and the sound acquired by the microphone 46. For example, the status determining unit 52 determines the level of excitement from the facial expressions of the visitor, and determines a photo opportunity if the level of excitement is high. Further, in the photo opportunity, under the control by the processing unit 42, the imaging unit 44 acquires a still image with high resolution, and the storing unit 48 stores the still image therein. Note that, as mentioned above, the status determining unit 52 may determine a photo opportunity using the AI or the like. Moreover, a speaker, a display unit, and the like may be provided to cause a person to be a photographed subject to pay attention to the facility camera 24. Sound or display that the person will notice, such as “please face in this direction”, can be performed.

Visit Record

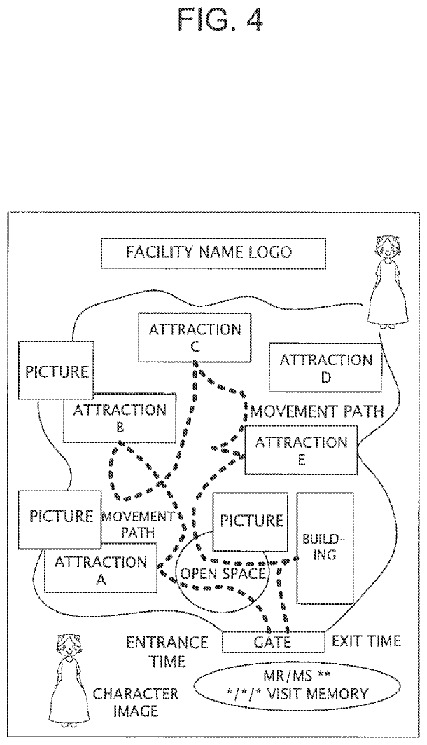

FIG. 4 is a diagram schematically illustrating one example of a printed item (print) of a visit record. In this manner, a map of the amusement facility and movement paths on which a visitor has moved on the map are displayed. Note that in the amusement facility including a plurality of divided areas of different tastes, the visit record may be limited to one area or may cover all the areas. Moreover, as mentioned above, a visit record to be provided is not necessarily printed matter, but may be data which may be downloaded or stored in a recording media.

A facility name logo is displayed at an upper portion. A name of a visitor (normally, registered nickname) and a date of visit are displayed at the lower portion. In this example, entrance time and exit time are displayed near the gate 12.

Further, pictures are displayed in association with the photographed positions. The picture is a still image at the time of the photo opportunity mentioned above. In the illustrated example, pictures photographed in an attraction A, an attraction B, and the open space are incorporated.

In this manner, in the visit record, pictures photographed in the respective places are displayed on the map of the amusement facility with the movement paths, so that the visitor who receives the visit record can be reminded of the action in the amusement facility, and enjoy the pictures as a memory therein.

Moreover, an image of the character in the amusement facility is printed together to make the visit record more enjoyable.

Note that a fee for the visit record may be included in the entrance fee, or may be an extra fee.

Data Sheet

In the abovementioned example, movement paths and pictures are mainly included in the visit record. However, other information on the visit can be provided as a record. The data sheet may be additionally written to the printed matter of the abovementioned visit record, or may be an extra sheet.

(i) Data of attractions used by a visitor and shopping items in shops is stored in a memory. The data for the visitor should be associated with the ticket 20, whereby data thereof can be acquired by identifying the ticket 20. If electronic data is stored in the ticket the electronic can be acquired from the ticket 20. The electronic data may be used for creating the Data sheet. The electronic data for the visitor may be identified by using the facial recognition.

(ii) Ranking in Group

In a case where visitors visit as a group, the visitors can be registered as the group. The group is registered in accordance with data input by the visitors. Further, data on amount spent on shopping, the number of usage attractions, the usage fee of the attractions, and the like is collected, and the ranking in the group is determined and is provided to the individual visitors.

In addition, the number of footsteps, the consumed calories, and the like can also be detected for each visitor using the function of the ticket 20 and lending of a special device, and the ranking of those may be provided. Moreover, from the images acquired by the facility cameras 24, “yawning” of each visitor is detected, and a ranking of the number of yawns can also be determined and provided.

1. A visit record providing system that provides a visit record to a visitor of an amusement facility in commemoration of a visit, the visit record providing system comprising a processor configured to:
acquire movement path information on the visitor of the amusement facility;
acquire a picture of the visitor taken at a prescribed place on the movement path; and
create the visit record by combining the acquired movement path with the picture, wherein
the created visit record is provided to the visitor.

2. The visit record providing system according to claim 1, wherein the picture includes a picture acquired by a camera installed in advance in the amusement facility or a camera installed in a movable body that moves in the amusement facility.

3. The visit record providing system according to claim 1, wherein the picture is a picture acquired by identifying the visitor through face authentication.

4. The visit record providing system according to claim 3, wherein a plurality of pictures for the identified visitor are acquired, a level of excitement of the visitor is detected, and the picture in which the detected level of excitement is high is selected.

5. The visit record providing system according to claim 1, wherein the processor acquires information related to the place where the picture is acquired, and adds the acquired information to the visit record.

6. The visit record providing system according to claim 1, further comprising a printer as a device in the amusement facility, wherein
in a case where the visit record is output from the printer, the visit record is printed out by adding a specific image stored in advance.
